(19) United States
(12) Patent Application Publication
(10) Pub. No.: US 2024/0342891 A1
(43) Pub. Date: Oct. 17, 2024

(54) Tool Handle with Cooperative Fastening Mechanism

(71) Applicant: Kilroy's Workshop, Inc., Colorado Springs, CO (US)

(72) Inventors: Ronald Mark Hardman, Peyton, CO (US); Gracen Alessandro Gonzalez, Colorado Springs, CO (US)

(21) Appl. No.: 18/631,458

(22) Filed: Apr. 10, 2024

Related U.S. Application Data
(60) Provisional application No. 63/496,464, filed on Apr. 17, 2023.

(51) Int. Cl. B25G 3/26; B25G 1/00; B25G 3/30; B33Y 80/00

(52) U.S. Cl. CPC B25G 3/26; B25G 1/00; B25G 3/30; B33Y 80/00

(57) ABSTRACT

Disclosed are manufactured articles, and methods therefor, for forming and attaching grips, handles and coverings for tools where a fastener for securing an outer cover is designed in coordination with a complementary shaped opening in the outer cover and the fastener and outer cover both comprise features to mechanically engage one another. In preferred embodiments, the outer cover and fastener are designed together in a common 3D modeling computer application and are then additively manufactured based on the complementary shaped models of the outer cover and the fastener.

### TECHNICAL FIELD

The present invention pertains to the field of fasteners for joining laminar structures and, more particularly to additively manufacturable low profile fastening implements designed for use with handles of tools, knives and the like.

### BACKGROUND OF THE INVENTION

Common fasteners for securely joining or attaching items, such as two or more plates of metal plastic or fabric, include rivets, screws, nuts and bolts. In the manufacture of handles for cutlery, folding knives, swords, hand tools and other implements, permanent and secure attachments are sought by employing rivets or the like. To provide long service life without corrosion, fasteners may be made of stainless steel or of other base metals having protective coatings such as nickel/chrome plating. These fasteners may be expensive and add cost to the manufactured item.

Some manufacturers specialize in making high quality, high value knives with special features and various mechanisms for deploying, locking into position for use and stowing a blade within a handle. The blade itself may be of exceptional material quality, strength and sharpness and may feature holes, profiles or jimping depending on the intended use and the user motion required to deploy the blade. The blade may have ornamental or aesthetic features as well. Commensurate with blade quality and overall knife quality, ergonomics and aesthetics, a handle or body for stowing the blade may incorporate many advanced design features and use enhanced materials, textures or features for improving grip, safety and suitability for specific uses. Some producers of such knives seek to include custom designs that are related to branding or customization or are commemorative in nature.

A typical body or handle for a folding knife often comprises a stacked assembly of more-or-less flat elongated pieces to form a housing, the pieces being shell, spine, locking mechanisms often made of a deflectable leaf spring of the like, outer handle fasteners that may be used to ‘liner’ and often an outer shell for enhancing grip and stability and for adding appearance. Whereas the strength-critical parts of the knife housing may be made of metal, the outer shell is often made of plastics or plastic composites, fiberglass, naturally occurring materials such as wood, turquoise or dentin, or synthetic versions thereof. With some materials to be fastened, the use of rivets, which require a minimum localized force to effect deformation, creates a risk of applying excessive concentrated forces that damage or split the materials being joined. The subsequent removal of a rivet involves drilling or grinding, also risking damage to surrounding parts.

In more general applications involving covers, grips or shells attached to shafts, tangs, levers or handles of tools and implements, conventional fasteners and their associated openings and cavities may create the problems mentioned above and, furthermore, may be difficult to replace and hard to clean and may they entrap contaminants or harbor toxic or pathogenic materials.

The utilization of conventional materials such as plastics for outer shells and of conventional fasteners such as rivets and screws for rigidly attaching the shells to the knife components adds cost, detracts from the aesthetic appearance and limits flexibility in aesthetic design. Thus, a need exists for alternative means for fastening, joining or attaching substantially laminar components without the aforementioned disadvantages.

### SUMMARY OF THE INVENTION

By way of various example embodiments, the present teachings provide for improved fastening, joining and affixing of materials, especially in applications where the fastening mechanism is preferably inconspicuous and does not protrude from or disrupt surfaces that have a functional or decorative purpose. One area of application relates to the manufacture of high quality pocket knives wherein the creation and secure attachment of an outer shell and a cooperatively designed fastener may be implemented by, and especially facilitated by, additive manufacturing techniques. In some applications, fastening techniques described herein may be applied to making replaceable components, such as tool handles, wherein the outer appearance may or may not be important but the ability to readily change or customize gripping surfaces may be of great utility.

### BRIEF DESCRIPTION OF THE DRAWINGS

Various exemplary embodiments are illustrated by way of example, and not by way of limitation, in the figures of the accompanying drawings, in which like reference numerals refer to similar elements and in which:

FIGS. 1A-1C depict various prior art approaches to fastening a plurality of laminar components as might be encountered in making handles for knives or other tools;

FIG. 2 is a pictorial showing outer coverings and fastening components in accordance with an exemplary embodiment of the present teachings;

FIGS. 3A-3E are close-up images of a shaped opening in an outer covering and a fastener being inserted in the opening in accordance with an exemplary embodiment of the present teachings;

FIG. 4 is a pictorial of an alternative design for outer coverings, fasteners and caps in accordance with an exemplary embodiment of the present teachings;

FIGS. 5A-5D present a fastener in various orientations to shown concave portions designed to engage with protruding features of outer coverings in accordance with exemplary embodiments of the present teachings;

FIGS. 6A-6C depict on-axis views of a fastener placed into an opening through outer cover members and progressively rotated form a unlatched orientation to a latched orientation in accordance with exemplary embodiments of the present teachings;

FIG. 7 is a cross section view of a fastener holding outer cover members and securing other components in accordance with exemplary embodiments of the present teachings;

FIG. 8 is a pictorial of another alternative design for outer coverings and internally captured fasteners in accordance with exemplary embodiments of the present teachings;

FIG. 9 is a pictorial view demonstrating the engagement of an internally captured fastener with protruding tab features of outer cover members in accordance with exemplary embodiments of the present teachings;

FIG. 10 presents a fastener of alternative design shown from various viewing angles in accordance with exemplary embodiments of the present teachings;

FIG. 11 is a cross-sectional view of an internally captured fastener holding outer cover members and securing other components in accordance with exemplary embodiments of the present teachings;

FIG. 12 shows several exterior faces of a handle that has been assembled using internally captured fasteners in accordance with exemplary embodiments of the present teachings;

FIG. 13 depicts an actuating tool suitable for engaging concave notches in some designs of fasteners in accordance with exemplary embodiments of the present teachings;

FIG. 14 depicts an alternative actuating tool suitable for engaging concave notches in some designs of fasteners in accordance with exemplary embodiments of the present teachings;

FIG. 15 is a close-up view showing engagements between fasteners and end caps in accordance with exemplary embodiments of the present teachings;

FIG. 16 depicts a process flow for applying a common pattern of surface relief to both a fastenable member having an opening and another component insertable into the opening in accordance with exemplary embodiments of the present teachings; and

FIG. 17 is a conceptual diagram of a process for modeling and then additively manufacturing a fastenable member and interoperating fastening components in accordance with exemplary embodiments of the present teachings.

### DETAILED DESCRIPTION

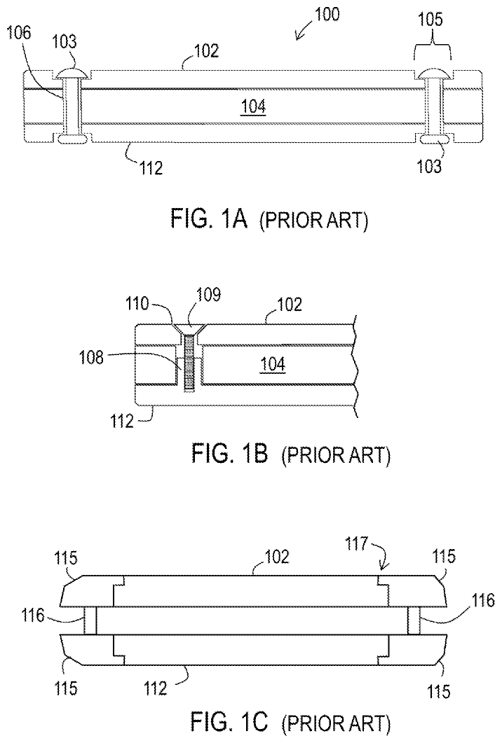

FIG. 1A depicts the handle of a common type of folding knife 100. For simplicity, any blades or tangs thereof, internal scales, springs and other deployable implements housed within the handle are simply shown as block 104 disposed between what shall be termed an ‘upper’ handle covering 102 and a ‘lower’ handle covering 112. These outermost coverings 102 and 112 may each also serve as a grip surface and be referred to simply as a ‘grip’. This applies to all analogous coverings that are subsequently shown in the present description.

Of particular note, FIG. 1A depicts a pair of rivets 103 or similar deformable fasteners inserted through passages 106 on either end of the handle assembly 100. Once each rivet 103 is inserted through passage 106 in the course of assembling the knife handle, one or both ends of the rivet (or brad) are bent, distorted or spread so that the rivet is permanently affixed and serves to keep coverings 102 and 112 and contents 104 held together firmly. To allow a head end of rivet 103 to settle into a fixed position and to drop to a position that is more or less flush with the surface of coverings 102 and 112, a counterbored opening 105 serves as a shallow well to accommodate the head end of the rivet or, oppositely, the tail end of the rivet. Although a rivet, per se, is shown here it may also be possible to use threaded fasteners or the like. In some common implementations, rivets are designed to fully occupy the space of counterbore 105 and to be finished flush with the outer surfaces of both coverings 102 and 112.

FIG. 1B depicts an alternative fastening arrangement involving covering 102, contents 104 and lower covering 112 wherein covering 102 comprises a countersunk hole 110 into which a flat head or oval head screw 109 may be inserted and achieve a relatively flush or mildly protruding profile with respect to this outer surface of covering 102. To receive and engage the threads of screw 109, lower covering 112 is shown to comprise a post or boss member 108 which may be formed continuously with or as a part of lower covering 112 and may either be a material into which threads may be formed if screw 109 is self-tapping, may be formed with threads intact or be tapped to create threads during manufacture. Alternatively, boss member 108 may be a portion of cover 112 into which a metal threaded insert is placed to accommodate the threads of screw 109. While the arrangement of FIG. 1B may be considered advantageous for presenting an outer surface on covering 112 that is uninterrupted by the placement of a fastener, the formation of boss 108 complicates the manufacturer of outer covering 112 and conceivably results in a weaker attachment keeping the entire assembly held together. As with both FIG. 1A and FIG. 1B, where there is possible contact between metal parts such as screw 109 or rivet 103 with other parts of the assembly, careful consideration must be given to contact among dissimilar metals wherein galvanic currents may promote corrosion.

FIG. 1C provides yet another example for coupling an upper covering 102 and a lower covering 112. For clarity, the other contents of the assembly that would be held in place between these two surfaces are excluded in this diagram. In FIG. 1C, covering 102 and covering 112 are shown to be unpenetrated by openings to allow for fasteners but are instead held in place by connected or overlapping bolsters 115 which, in turn, provide connecting features 116 for passing through openings in the remainder of the assembly. Connecting features 116 may include posts, studs or threaded members or even deformable metals or the like to achieve a fastening through the assembly. Whereas bolsters 115 may be made of metal, plastic or other materials, the fact that neither covering 102 or covering 112 are penetrated makes it possible to use more brittle materials such as glass, ceramics, wood, acrylic polymers, soft stone or naturally occurring materials that may be susceptible to splitting or shattering if an excessively concentrated force were to be applied from fasteners such as rivet 103 or screw 109. (Some of these materials may be suited for ornamental purposes but too fragile for normal practical use.) In the configuration of FIG. 1C, a significant disadvantage in terms of the complex formation of the trapping overhang 117 or a similar feature, as well as the need to provide a flush and effectively permanent form of attachment to join opposing bolsters 115, makes for a complex, time-consuming and inflexible type of manufacture for this article. From an aesthetic standpoint, the bolsters necessarily occupy a significant portion of the outer surface which limits the freedom to design either dimensional relief features to promote grip, or decorative and aesthetic relief features and surface graphics.

Accordingly, in view of the various forms of assembly during manufacture depicted in FIGS. 1A through 1C, there are significant limitations in the prior art for creating a handle or covering where the means of fastening and holding the assembly together are both inconspicuous and yet readily changeable.

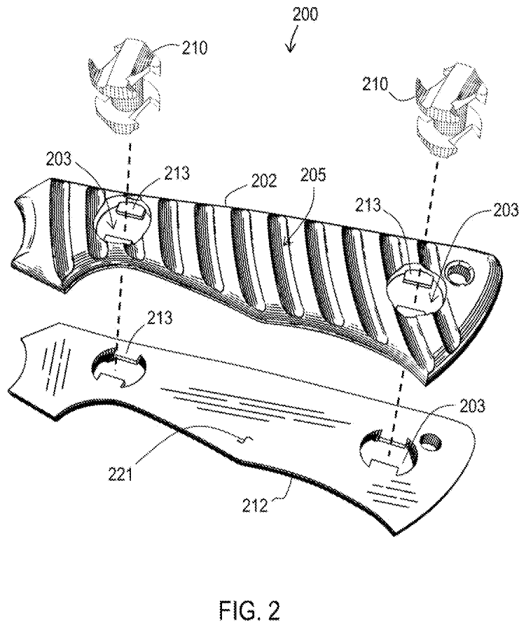

FIG. 2 depicts a handle assembly 200 comprising upper covering 202 and lower covering 212 in accordance with an exemplary embodiment of the present teachings. It should be noted that other functional components are to be encapsulated or ‘sandwiched’ between these outer coverings but are excluded from this pictorial diagram for the sake of simplicity. The other items to be captured between coverings 202 and 212 may include, for example, the tang of a fixed knife blade, the liners, scales and blade of a folding knife, or even the flat shaft of a hand tool such as a drywall hole saw or a trowel. The upper covering 202 and lower covering 212, as well as any analogous structures shown elsewhere herein, are examples of a wide range of possible items that need to be fastened or attached and may be referred to as ‘fastenable members’ or ‘members to be fastened’.

In FIG. 2, both the upper covering 202 and the lower covering 212 are shown to comprise openings 203 (in this case a total of four openings) which completely penetrate the thickness of the respective covering and are shaped to allow passage of fasteners 210 when the fasteners are turned to a particular initial rotational orientation as will be explained below. Each of the openings 203 is also shown to feature a pair of inwardly protruding tabs 213 which will engage portions of fasteners 210 once the fasteners 210 have been inserted through both upper covering 202 and lower covering 212 and then rotated as will be shown in subsequent figures.

In FIG. 2, upper covering 202 is shown to have a series of grooves forming a surface pattern, relief pattern 205, which may be functional to improve grasp as well as offer some aesthetic value. Although not clearly visible in FIG. 2, the side of lower covering 212 facing outward may have a similar or symmetrical relief pattern as shown on upper covering 202. An inward face 221 of lower covering 212 is shown as being flat and smooth and this surface corresponds to the line shown between covering 102 and contents 104 as were shown in FIG. 1A. While this smooth surface may be preferable in many cases, concavities or protrusions may sometimes be appropriate on this surface for alignment purposes or enablement of other features of the overall manufactured item. In accordance with preferred embodiments of the present teachings, however, the presence of a flat surface here, perhaps with concavities or wells into the surface, usefully allow coverings 202 and 212 to be particularly amenable to manufacture by additive manufacturing techniques such as fused filament fabrication (FFF) onto a flat print bed. Although not visible in FIG. 2, the ‘underside’ of covering 202 may exhibit the same smooth, inward-facing surface.

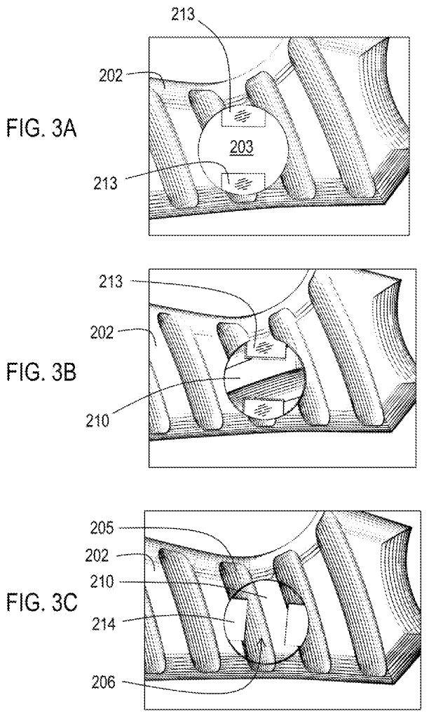

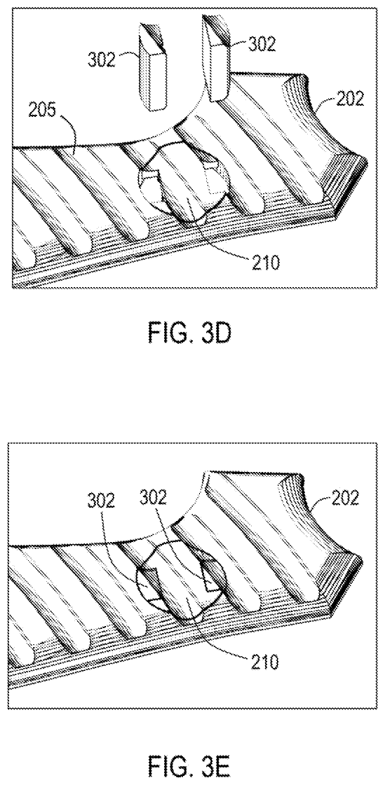

FIGS. 3A-3C depict a sequence of motions by which fastener 210 may be placed into opening 203 and then rotated to secure attachment of covering 202 to opposite covering 212, in addition to securing in place any other members, components or contents of the manufactured article therebetween.

In FIG. 3A, a close-up of upper cover 202 is shown along with shaped opening 203 through which fastener 210 will be inserted. FIG. 3A clearly shows tabs 213 protruding inward from the walls of the otherwise cylindrical opening 203. FIG. 3A shows opening 203 before fastener 210 has been introduced into the opening.

FIG. 3B depicts a single fastener 210 having been inserted into opening 203 by direct linear motion normal to the plane of the image, in what may also be termed a ‘translating’ or ‘sliding’ motion in line with a central axis of the fastener. Note that, as the fastener is lowered into opening 203, concave openings in the fastener in an axial direction permit fastener 210 to slide downward into opening 203 without contacting tabs 213. In FIGS. 3C, fastener 210 is retained at an insertion depth that was achieved in FIG. 3B such that the top end of fastener 210 is flush with the outermost surface of cover 202.

In FIG. 3C, fastener 210 is then rotated, in this case by about 90°, in such a manner that the relief pattern 206 formed on top of the fastener 210 comes into alignment with the surrounding relief pattern 205 of upper cover 202. Furthermore, this rotation-in-place causes tabs 213 to become occluded by, and seated within, a concave portion of fastener 210. Note that, upon this rotation, a portion of the original opening 203 is again open all the way and forming a passage from the outer surface of upper covering 202 to the outermost surface of lower covering 212. This is shown as ‘through opening’ 214. It is upon this rotation action that portions of fastener 210 come to bear against tabs 213 on both coverings and effectively secure upper cover 202, lower cover 212 and any other components captured in between. For as long as the fastener 210 stays rotated into the second rotational orientation shown in FIG. 3C, the overall assembly remains fastened together.

To continue steps towards a completed assembly, FIG. 3D provides an oblique pictorial view showing fastener 210 having been inserted into the opening 203 of upper cover 202 (and also through the corresponding opening in lower cover 212, although not shown here) and then rotated in the manner shown in FIG. 3C. The through openings 214 formed once fastener 210 is rotated may then be filled by retaining inserts 302 which are shown prior to their insertion FIG. 3D and then shown after their insertion in FIG. 3E.

As an important aspect in accordance with the present teachings, especially by way of using additive manufacturing to design and form arbitrarily shaped 3D printed parts, the upper cover 202 may be flexibly designed to include features such as relief pattern 205 and to provide for shaping of fastener both ends of fastener 210 as well as the ends of inserts 302 retaining inserts 302 such that the final assembly results in a consistently patterned surface and wherein any seams between moving parts are blended in and inconspicuous.

Aside from the ability, by virtue of using additive manufacturing to flexibly design and then form these cooperative parts with a coordinated surface relief pattern, the complementary parts may be formed at the same time in a singular additive manufacturing build process and using an identical feedstock material such that the outward appearance is completely consistent in color and texture. Furthermore, the behavior of the material during post-processing steps such as sanding, painting, vapor honing, bead blasting, etc. is consistent so that in the resulting final manufactured article the presence of the fasteners 210 and retaining inserts 302 remains unobtrusive and post-processing does not tend reveal them due to differential material behaviors as might be the case if the cover and fasteners were made of different materials, different lots of the same material or made under different conditions. This like-material concealment attribute also holds true of normal incidental wear during the utilization of the manufactured item by an end-user. Some painting, overcoating or solvent-exposure processes may even seal or conceal the slight gaps observed in FIG. 3E and may fuse the components in a semi-permanent manner.

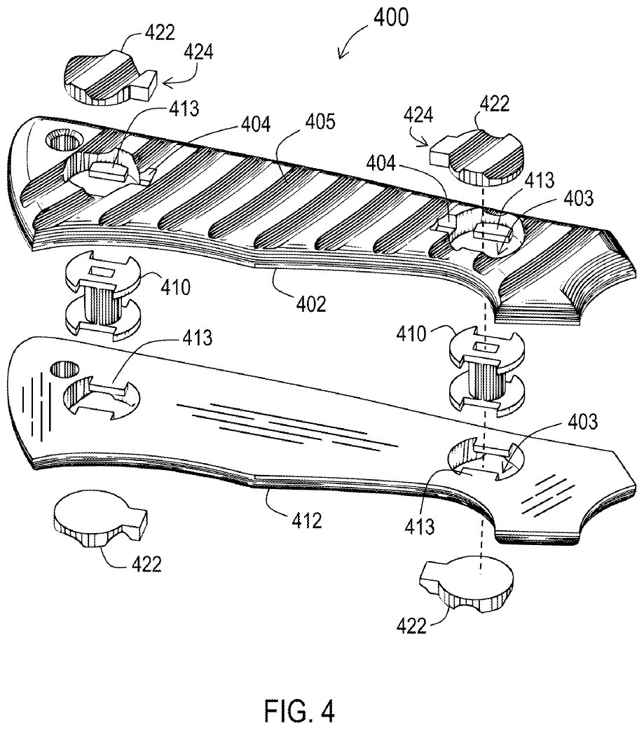

FIG. 4 shows an alternative arrangement in accordance with an exemplary embodiment of the present teachings wherein an implement handle 400 is shown to comprise upper cover member 402 and a lower cover member 412 as before.

Whereas in FIG. 2 and in FIGS. 3A-3E the relief pattern 205 was replicated in the tops of fasteners 210 and the tops of either end of retaining inserts 302, in FIG. 4 fasteners 410 are similarly intended to be inserted through openings 403 but do not have features attempting to replicate pattern 405. Instead, end caps 422 perform this role and are inserted after the placement and rotation of fasteners 410. End caps 422 replicate, duplicate or mimic the surface relief pattern of covers 402 and 412 and include alignment notches 424 which fit into additional notch voids 404 formed in the covers 402 and 412. Accordingly, the assembly procedure involves bringing together, in alignment, the upper cover 402, the lower cover 412 and any intervening components of the manufactured article and then inserting fasteners 410, rotating the fasteners so that they become fixed in position by bearing against tabs 413 and then installing caps 422 into the remaining volume of opening 403. Although the interior-facing side of each end cap 422 is shown here to be smooth, it is contemplated that some concavities or protrusions may be included and designed to engage features of fasteners 410, so that rotation of each fastener 410 is prevented as long as an end cap 422 is installed. Throughout the present teachings, and for any of the embodiments, components, surfaces and features shown herein, it should be appreciated that flats, tapers, notches, inclined surfaces, grooves, indentations, latching or ratcheting actions, detents, glue-fillable cavities, insertable pins, roughened surfaces, eccentricities, distorted or out-of-round shapes may be incorporated to achieve a desired frictional or mechanically secured fit that prevents fasteners from rotating or otherwise loosening.

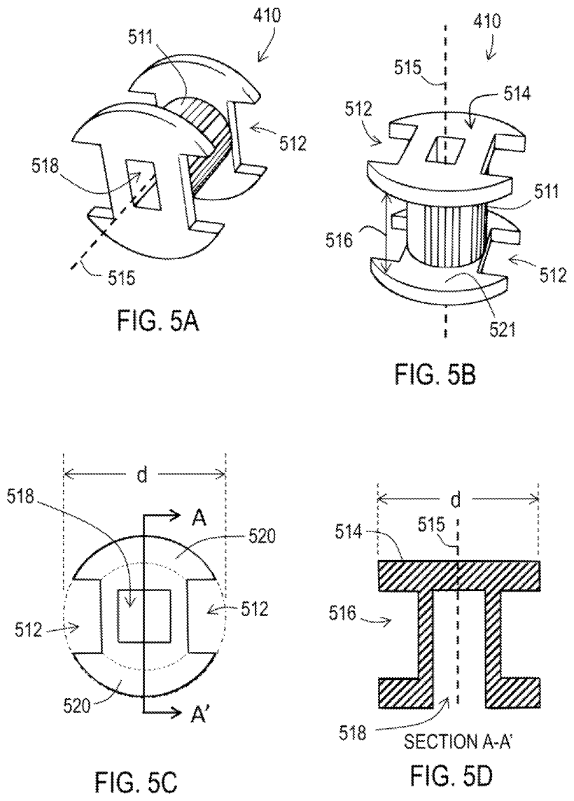

FIGS. 5A and 5B show fastener 410 viewed at two different angles to more clearly show several features in accordance with a preferred embodiment. In FIG. 5A, fastener 410 is shown to preferably exhibit a generally cylindrical outer shape oriented around a central axis 515. Fastener 410 may be viewed as having two flat ends or axial ends, corresponding to the flat, circular bases at either end of a cylinder. The construction of fastener 410 may either be viewed as a central core 511 centered on the central axis 515 and having radial outcroppings in a particular shape or may be construed to be a cylinder with concavities carved away both axially and circumferentially. To allow passage of inwardly protruding tabs 413 as fastener 410 is first inserted by linear motion into opening 403 (as was described earlier) fastener 410 is shown to comprise at least one axial concavity 512 formed parallel to central axis 515 and preferably elongated in the axial direction as shown. Furthermore, to permit fastener 410 to engage tabs 413 by rotation after being inserted to a particular insertion depth adequate to engage tabs 413 of both upper and lower coverings, fastener 410 in FIG. 5B is shown to comprise a second concavity 516 that is defined circumferentially relative to central axis 515. To accommodate the entry and passage of tabs in the fastener, first axially via the axial concavity and then circumferentially via the circumferential concavity, concavities 512 and 516 are said to be confluent or connected or intersecting, though they are aligned in orthogonal directions.

Although this shape shown can be manufactured by machining a cylinder of solid material by milling along a direction parallel with central axis 515 to form a lengthwise channel corresponding to concavity 512 and then rotationally turning the billet of solid material, such as by using a lathe to reduce the diameter of the cylinder down to the core 511 shown (or by performing the turning and then milling), the preferred method for forming fasteners 410 in accordance with the present teachings is to use additive manufacturing such as fused filament fabrication (FFF), liquid stereolithography (SLA), selective laser sintering (SLS) or directed energy deposition (DED). Even if particular custom relief patterns are not to be applied to either fastener end surface 514 in the manner shown previously for fasteners 210 shown in FIG. 2, the use of additive manufacturing allows for iterative fine-tuning of fit such as adjusting the tightness of fit between upper cover 402, lower cover 412 and any other intervening components of the assembly. The use of additive manufacturing also allows for including a shaped hole, tool opening 518, to receive a tool to assist with turning the fastener 410 once it has been inserted to a specific depth into contact with the upper and lower covers.

A tab contacting surface 521 is the portion of fastener 410 that will come into contact tabs 413 upon the insertion and rotation described herein. This inner wall of the circumferential concavity is responsible for the fastening action to hold the coverings and overall assembly together.

Whereas FIGS. 5A and 5B depict fastener 410 pictorially in perspective, FIGS. 5C and 5D provide an on-axis view and a radial cross-section view of the same fastener shape. FIG. 5C shows the fastener 410, when viewed on end, to be defined within a circular outer shape and, ideally, the diameter of this circular outer shape should be slightly smaller than the size of, for example, cylindrical opening 403 depicted earlier. Subtracting from this outer shape, concavity 512 is depicted as in the form of a notch that runs the length of the fastener and, as described earlier, serves as a passage through which tabs 413 are able to pass through as the fasteners are inserted by linear motion relative to the cover members that are to be bound together. Thus, concavity 512—ideally running the length of the fastener 410 for use as shown in FIG. 4 (or running the length of the fastener 210 for use as shown in FIG. 2)—may be referred to as a first concavity for permitting fastener 410 to slide into opening 403 despite the presence of inwardly protruding tabs 413, as long as the fastener 410 is inserted at a particular initial rotational orientation. It should be noted that, while two tabs 413 are shown in FIG. 4, a different number of tabs may be utilized and that fastener 410 may exhibit rotational symmetry with an order different than the order of two that is depicted in FIG. 5C. For example, three tabs may be provided in covers 402 and 412 in which case fastener 410 would correspondingly have three lengthwise concavities 512 disposed at intervals of 120° about central axis 515.

Also indicated is a tab-overlapping portion 520, the bounds of which are denoted by a dotted line. Aligned with tab contacting surface 521, tab-overlapping portion 520 is useful for explaining the visual occlusion and mechanical constraining of tabs 413 as fastener 410 is rotated.

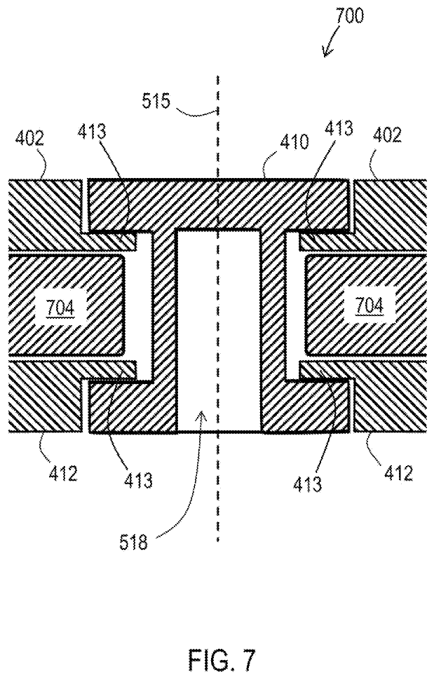

FIG. 5D shows a cross-sectional view of fastener 410 as indicated from the point of view indicated by the cross-sectioning callouts in FIG. 5C. FIG. 5D allows a better view of what may be termed a second concavity that is form circumferentially, for example, by radially inward subtraction of material from the walls of the outer cylinder. Of course, when additive manufacturing processes are utilized in accordance with the preferred embodiment of the present teachings, this fastener may be formed without material here or with only removable or soluble support materials that are subtracted after forming the fastener and leaving circumferential void or concavity 516. Circumferential concavity 516 serves to receive and confine one or more tabs 413 as fastener 410 is rotated, thereby capturing tabs 413 in both upper cover 402 and lower cover 412. (This will be further described in connection in FIG. 7.)

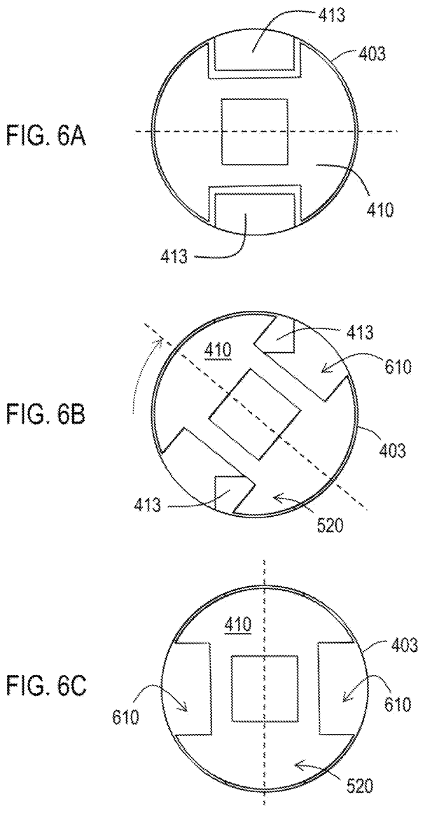

FIGS. 6A through 6C depict a close-up of an opening 403 into which fastener 410 is inserted and then undergoes rotation to secure upper and lower coverings and enter any intervening components of the article being assembled.

In FIG. 6A, the outermost circle of the diagram represents opening 403 or multiple such openings that are aligned to form a cylindrical through-hole. In FIG. 6A, two tabs 413 are shown as projecting inwardly from the walls of cylindrical opening 403. The majority of the remaining void is filled by fastener 410 that has been inserted into the opening. Of particular note, fastener 410 has been slid into the opening while in a first rotational orientation that allows concavity 512 identified earlier to slide past tabs 413. Fastener 410 may be inserted to a point at which it is completely submerged below the outermost surface of upper cover 402 and also within the confines of the outer surface of lower cover 412.

In FIG. 6B, with all other surfaces remaining stationary, fastener 410 is shown to have been rotated to an extent that tabs 413 enter into the second circumferential concavity 516 as was described earlier. At this point of rotation, fastener 410 no longer has the freedom to move in an axial direction and the upper and lower covers, as well as any intervening components, are effectively held in place clamped together by the interference by the tab-overlapping portion 520 as a radial outcropping of fastener 410. Another aspect shown in FIG. 6B, as fastener 410 is in a state of partial rotation towards a fully engaged position, is ‘through-opening’ 610 which enlarges as fastener 410 continues to be turned clockwise in this example.

Finally, in FIG. 6C, fastener 410 is shown to have been rotated clockwise by 90° after having been inserted in opening 403, at which point the tabs 413 are completely occluded by the tab overlapping section 520, meaning that they are in firm contact with tab-contacting surfaces 521. This positioning represents the culminated engagement of fastener 410 with the cooperating portions of covers 402 and 412, namely tabs 413. At the same time, through-openings 610 have expanded to their maximum area and these are portions where opening 403 is completely open through both upper and lower coverings.

FIG. 7 shows a cross-sectional view 700 depicting a situation in which fastener 410 has been inserted by linear motion along its central axis 515 into a cylindrical opening, such as opening 403, and, while in a first rotational orientation comparable to FIG. 6A, is then rotated to a second rotational orientation as in FIG. 6C to engage multiple tabs 413-a total of four such tabs in this scenario. Upon the entry of tabs 413 into the circumferential groove or concavity of fastener 410, along with entrapping any intervening components 704, all of these members have become rigidly assembled together and inseparable until the fastener 410 is turned back to the first rotational orientation shown in FIG. 6A. It is a distinct advantage of the various embodiments in accordance with the present teachings that the action of fastener 410 is easily reversible to allow detachment of covers 402 and 412 by returning the fastener 410 to the first rotational orientation so that axial motion becomes allowed again. This attribute of the present teachings allows for quick change of handle coverings, grips or other items being attached using the mechanism just described.

As an aside, it is noted that, in FIG. 7, the outer surface of covering cover 402 appears to end up flush with one end of fastener 410. This may be the desired end result if an implementation similar to FIG. 2 is sought. Alternatively, however, the top surface of fastener 410 shown in FIG. 7 might also be well below outer surface of cover 402 when implemented similarly to FIG. 4 such that room is left above fastener 410 to accommodate an end cap 422.

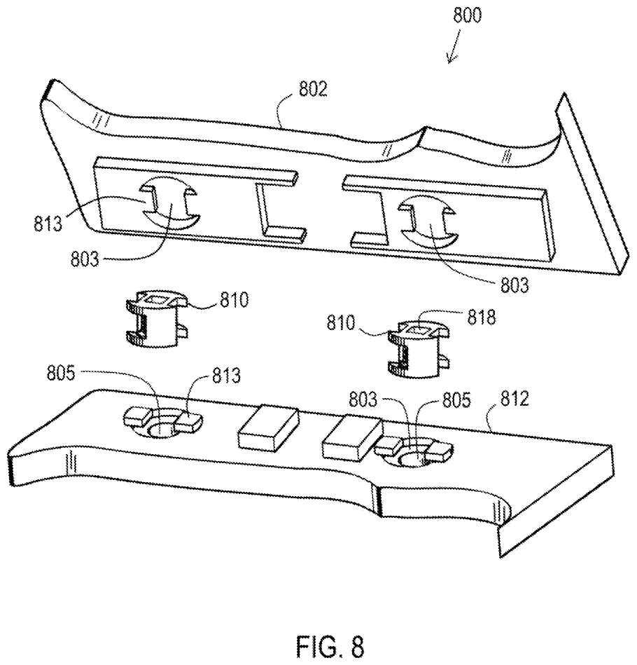

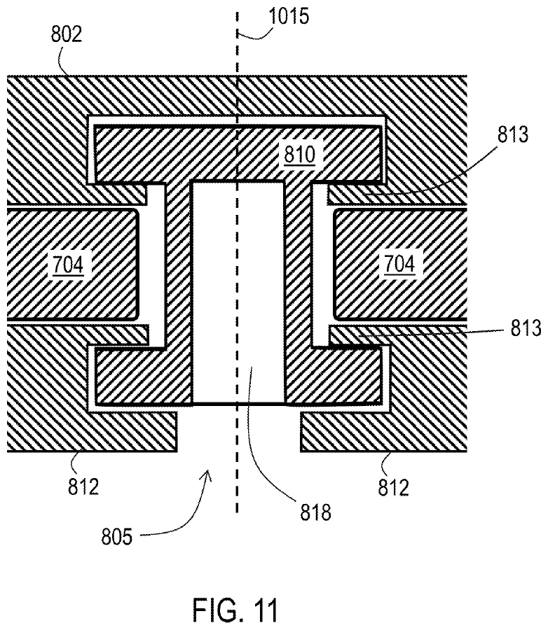

FIG. 8 is a pictorial diagram depicting yet another example embodiment, handle assembly 800, wherein an upper cover 802 and a lower cover 812 are to be bound together while entrapping any other components of the assembly therebetween. In contrast to assemblies 200 and 400 depicted earlier, the upper cover 802 includes openings 803 for accommodating fasteners 810 but the openings 803 do not penetrate the outer surface of upper cover 802. (This may be best understood by brief reference to the cross-sectional view of FIG. 11.) The opposite cover, lower covering 812, also differs in that an opening 805 that does penetrate the outer surface is just large enough to accommodate a tool that might enter a tool hole 818 of fastener 410, but not large enough to allow the passage of entire fastener 810 through cover 812. Instead, in the arrangement shown in FIG. 8, each fastener 810 is designed to be captured between covers 802 and 812 and then rotated by the use of the tool reaching through holes 805 and engaging tool holes 818 in each fastener. Stated another way, the openings 803 indicated in the upper cover 802 may be characterized as wells or shaped concavities for accepting the upper portions of fasteners 810. As a particular advantage of utilizing an additive manufacturing technique for the fabrication of these handles, coverings or grips, the formation of these openings 803 with integral tabs 813 are greatly facilitated in comparison to traditional machining and subtractive techniques known in the art. The present teachings arise in the recognition that such features now enabled by the recent advent of additive manufacturing and create new opportunities to produce better solutions for customized fitted, ornate or bespoke handle designs as well as to facilitate ad hoc manufacturing and ease of replacement that have been heretofore unrealized using traditionally available fasteners and manufacturing techniques.

The formation of the through-holes and overhanging tabs depicted for the lower cover 812 are similarly challenging for traditional manufacturing techniques but are readily achievable using additive manufacturing. In many cases, additive manufacturing provides for overhangs, removable support materials including soluble differentially soluble materials that enable fine details and the forming of concavities that are difficult to produce by subtractive machining and impossible to produce using injection molding techniques. Examples of soluble supports include water-soluble (yet printable) materials such as polyvinyl acetate (PVA) and differentially soluble materials, such as when printing a part out of ABS and using high-impact polystyrene (HIPS) as a soluble support material that may be dissolved using a solvent such as d-limonene, to which ABS is impervious.

The raw materials from which handles or grips of this type (or any other embodiment described or claimed herein) may be formed include, but are not limited to, metals, plastics, composite plastics having glass fiber or carbon fiber or other fibrous or particulate fillers, fiberglass, ceramics, glass, elastomeric compounds including thermoplastic urethane. All of which are amenable to various types of additive manufacturing. It is contemplated that fasteners 810 might be formed of sintered titanium and that outer covers may be made of particularly strong, temperature-tolerant and solvent-tolerant material such as polyetherimide.

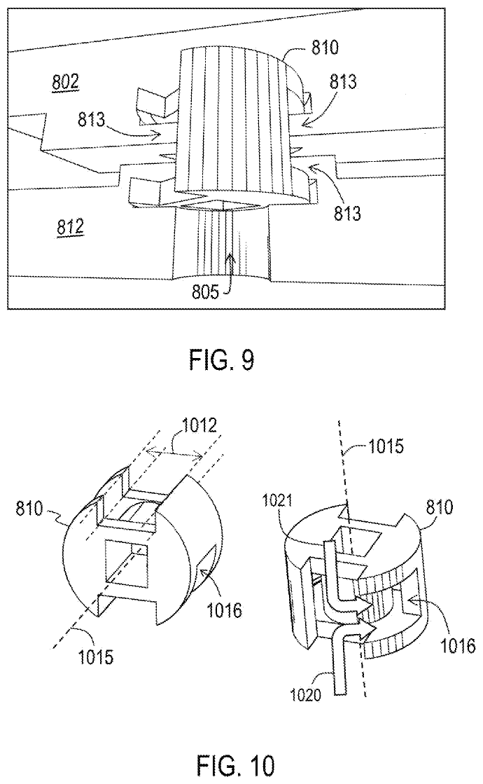

For illustrative purpose, FIG. 9 provides a pictorial view showing the engagement of fastener 810 after it has been trapped between upper cover 802 and lower cover 812 (both shown in cutaway view) and partially rotated. FIG. 9 shows the hole in lower cover 812 tool passage hole 805 through lower cover 812 providing a way for a rectangular or square tool to reach into tool opening 818 and rotate fastener 810 in place after it is been otherwise surrounded by members that it is serving to attach. Certain portions of fastener 810 are shown to have rotated into an overlapping position with tabs 813 at four different locations.

FIG. 10 affords a better view of fastener 810 and may be likened to the views of fastener 410 shown earlier in FIGS. 5A through 5D. Like the previous figure, fastener 810 in FIG. 10 is shown to exhibit a roughly overall cylindrical shape centered around a central axis 1015. In this figure, fastener 810 is also shown to feature a longitudinal void or concavity carved inwardly from the periphery, which may be referred to as a first concavity 1012. As was described before for concavity 512, this feature allows for the passage of tabs 813 as fastener 810 is inserted into openings 803 in upper cover 802 and lower cover 812. Similarly, FIG. 10 shows that fastener 810 has a second concavity 1016 that is disposed circumferentially within the body of fastener 810 similarly to the role described for concavity 516 in FIG. 5B. Concavity 1016 allows for rotating the fastener 810 in place and trapping tabs 813. For further clarification, the effective relative pathway of a tab of one outer covering entering engagement with fastener 810 by first linear motion and then rotational motion is indicated by arrow 1020. In complementary fashion, arrow 1021 shows that path of a tab from an opposite covering entering first by linear motion and then being confined in concavity 1016 by rotation of the fastener.

FIG. 11 is a cross-sectional view of the situation when fastener 810 has been inserted into receiving openings or concavities within upper cover 802 and lower cover 812 and has been rotated. This action may also clamp or trap other intervening components 704 which may be, for example, the tang of a knife blade or a complete folding knife assembly including liners, scales, and pivoting blade components. In FIG. 11, it is evident that the passage of parts of the upper cover 802 and of the lower cover 812, especially tabs 813 associated therewith, into circumferential concavity 1016 of fastener 810 has caused all members of the assembly to become bound together. The rotation of fastener 810 while captured internally between the coverings 802, 812 may be accomplished by insertion of a shaped tool, such as a square rod, through opening 805 in the lower cover and into the tool hole 818 of fastener 810. Such a tool can be used to rotate fastener 810 by 90° and then be withdrawn. This arrangement may have practical and aesthetic advantages.

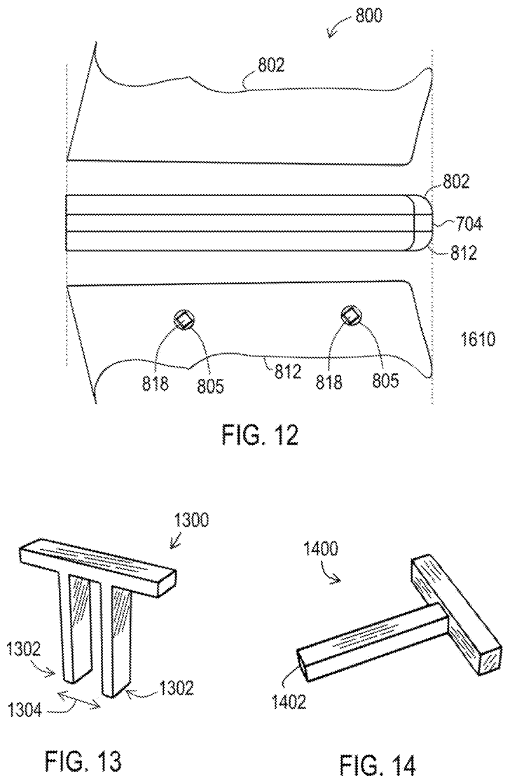

This latter attribute is portrayed in FIG. 12 which shows three aspects of the handle assembly 800 (including an outer surface view of upper cover 802, a ‘spine view’, and an outer surface view of lower cover 812) and demonstrates that the fastener arrangement described in FIGS. 8 through 11 results in at least one handle surface that is uninterrupted either physically or visually by the appearance of any fasteners or cavities therefore, and wherein the opposite side has only minimal, relatively inconspicuous holes for tool insertion. Not only is this arrangement advantageous for aesthetic and decorative purposes, but it also reduces opportunities for materials to become embedded or encrusted such as when handle 800 is applied in a dirty environment. For some envisioned applications, a noted advantage sought by the developers of this technique was to enable fast and easy change out of handler grip components in a work environment where handles might become contaminated or damaged. It is contemplated that removable plugs might be inserted into openings 805 between handle changes which could be pried out or unscrewed to allow access to tool hole 818 for disassembly.

FIG. 13 is a pictorial view of a tool 1300 that may be used for manipulating fasteners such as fastener 210 and fastener 410 in their respective scenarios. Tool 1300 may comprise a pair of tips 1302 of a specific size and spacing 1304 (matching the spacing between openings 610) to engage concave openings 512 at first and then to settle into through-openings 610 as a fastener attains the second rotational orientation. Tool 1300 may be used to install retaining inserts as shown in FIG. 3D or to eject the inserts when disassembly is needed. Advantageously, tool 1300 may be designed additively manufactured during the same build as other members such as upper and lower covers. It is contemplated that tool 1300 may initially be formed having retaining inserts 302 attached to facilitate alignment and insertion. Tool 1300 may be design and coordination with automatically coordinate with changes in size of opening 403 or the spacing between openings 610 or concavities 512 which may conceivably vary from part to part when one is making custom one-off or low-volume end products.

FIG. 14 is a pictorial view of an alternative tool 1400 that may be additively manufactured as well and may particularly provide a square, rectangular or otherwise matched shape tip 1402 to engage tool opening 518 or tool opening 818 shown earlier.

A tool handle according to the present teachings is particularly enabled by, and amenable to, fabrication by additive manufacturing, lending the added advantage of ubiquitous availability of supplies and 3D printing equipment to fabricate custom designed or replacement handles ‘in the field’ and on an as-needed basis.

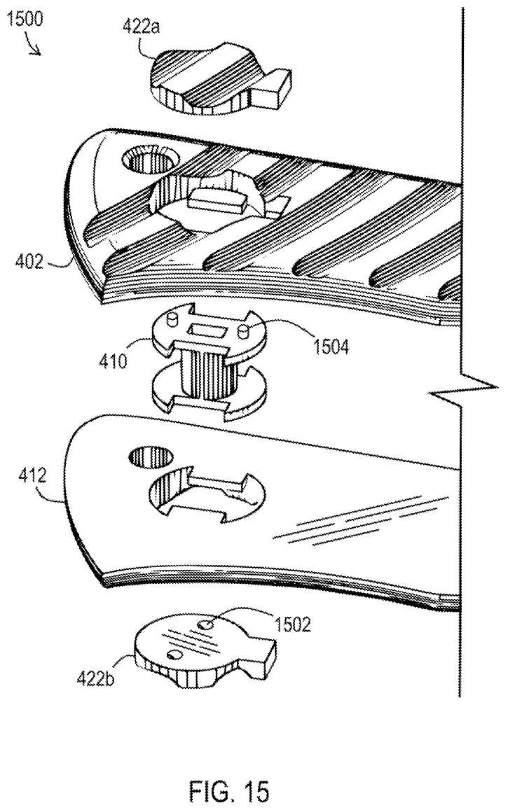

FIG. 15 provides a close-up view 1500 resembling the left side of FIG. 4 but demonstrating an optional feature that may be applied in some implementations according to the present teachings. As with FIG. 4, close-up view 1500 shows fastener 410 disposed between outer covers 402 and 412, though, as described before, the fastener comprises concave passages or gaps such that it may be inserted through openings in the coverings from either of the outward-facing surfaces thereof. Of particular note in view 1500 is the presence of one or more wells or cavities 1502 formed on what may be termed the inward-facing side of at least one of the caps 422a or 422b. (Although the inward-facing ‘smooth’ side of cap 422b is explicitly shown in this view, the occluded side of cap 422a may also have similar concavities.) For some types of 3D printing, such as fused filament fabrication (FFF), such a cap may be printed with the smooth side facing the build plate and concavities 1502 may formed as, for example, cylindrical or conical voids facing the build surface and with interior wall overhang angles mild enough that printed supports to counteract gravity are unnecessary.

Corresponding to cavities 1502, another optional feature is shown as protrusions 1504 formed on one or both axial ends of fastener 410. The role of protrusion 1504 is to enter and engage with a cavity 1502 once the outer covers and any sheathed contents have been assembled, fastener 410 has been inserted and rotated to lock the assembly together and caps 422 have been pressed into place. With caps 422 in place, cavities 1502 trap protrusions 1504 and prevent unwanted rotation and loosening of fastener 410. Importantly, the orientation of cavities 1502 assures that protrusions 1504 only engage when fastener 410 is rotated into a locking position. In practice, protrusions 1504 need only be formed on one end of a given fastener 410 to achieve this effect, further facilitating the additive manufacture of fastener 410 by orienting its central axis normal to a build plate.

Aside from the example arrangement of the cavities and protrusions shown in FIG. 15, many variations are possible in the number, location, size and shape of these complementary engaging features. The sense as to which component has a protrusion versus a concavity may be reversed. Furthermore, one or more caps 422a,b may be formed to engage with the existing shape of fastener 410, that is, without additional concavities or protrusions beyond what was introduced in FIGS. 5A-5B. For example, a cap 422a,b may optionally be formed with a centered square or rectangular protrusion that fits into tool opening 518 already present in fastener 410 as shown in FIG. 5A. A cap 422a,b may alternatively include protruding prongs that fit into the axial concavities of fastener 410.

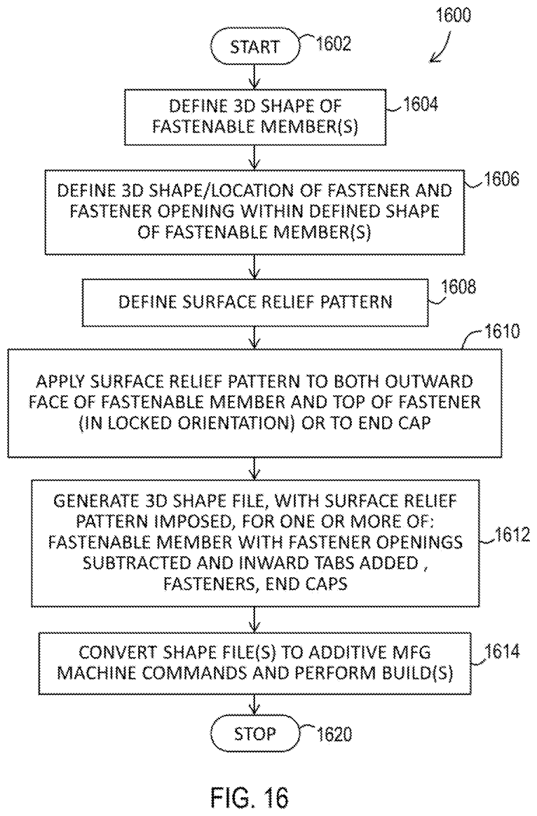

FIG. 16 depicts a process 1600 for applying a common pattern of surface relief to both a fastenable member having an opening and another component, such as a fastener or cap, that is insertable into the opening. Process 1600 commences in step 1602 upon the need to create one or more fastenable members (such as outer covers 402,412) and one or more fasteners or caps designed in coordination such that, when the latter are fitted into a complementary opening formed in the fastenable members, a consistent surface relief pattern is maintained across the outward surface collectively presented by the fastenable member and the applied fasteners or caps.

Immediately after commencement, execution of process 1600 continues with step 1604 wherein an end user defines, crafts, expresses or inputs data as to a desired outer shape of the finished article, such as the outer shell of a knife handle or tool handle. Many computer-hosted applications are well known for creating 3D model data sets such as STL files. In step 1606, the end user provides input as to the locations where fasteners are to be inserted into the fastenable member, whereupon a design application or workstation platform may perform constructive solid geometry (CSG) operations, such as differencing and intersection calculations, to effectively yield a model of the article, with a shape opening required for insertion of the fastener subtracted from the model at specific locations.

Next, in step 1608, a pattern of surface relief, such as relief pattern 205 introduced earlier, is selected or designed by an end user for application to the article. The pattern of surface relief may be viewed as locations at which the shape set forth in step 1604 is ‘carved away’. Alternatively, in a mode particularly enabled by additive manufacturing, a pattern of surface relief may be implemented by addition of mass or features that protrude outward beyond the original shape boundaries defined in step 1604. The depth of a relief pattern may range from shallow scratches forming an image to mild indentations to enhance grasp to deep or dramatic features for particular functional or ornamental purposes. Where a tool handle, such as a folding knife handle comprises two outer covers, the relief patterns of the respective sides of the finished article may be duplicated in mirror image or may be completely different and unrelated. For an ornamental knife, for example, the outward facing side of one cover may convey a scene or logo in deep relief whereas the opposite cover may bear a shallow inscription resembling an engraving.

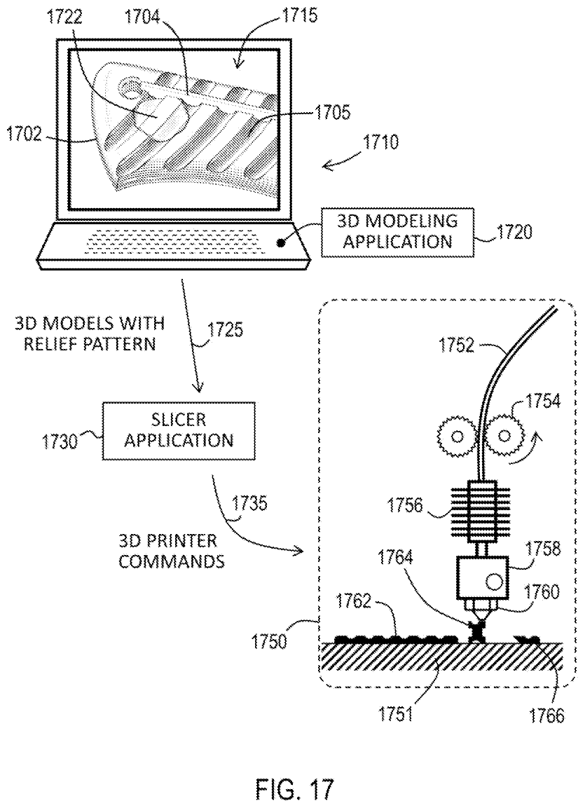

In step 1610, the pattern(s) of surface relief are applied to the model or models that describe the shape of the fastenable member and associated co-designed fasteners (with shaped tops as in fastener 210) or caps (as in cap 422). It must be emphasized that manipulating the outer covers (fastenable members) and coordinatively-shaped fasteners or caps as digital 3D models allows for applying the relief pattern by CSG operations and, conceptually at least, while the ‘bulk’ components are positioned as they would be in their fully assembled and locked positions. In fact, careful attention to this latter positioning aspect is crucial for assuring a seamless, concealed or visually consistent appearance of relief features across the outward face of the finished article once assembled as taught herein. This relationship will be further explained in connection with FIG. 17 below.

Once the CSG operations have altered the original surfaces of the fastenable members and mating fasteners or caps so the relief pattern will be present in the finished article, step 1612 is performed to generate the appropriately modified shape-describing data sets or data files. For example, there may two outer covers for a knife handle each of which is described by a 3D data model representing the net shape of finished cover shape, including any voids, concavities, holes or openings for fasteners or caps. As described earlier the generally cylindrical openings that may have been digital ‘subtracted’ from the cover shapes will also be processed to include inwardly protruding tabs, like tab 213. In addition, step 1612 would involve generating data models for fasteners which may also have end shapes affected by digitally applying a relief pattern as may have been applied to covers in step 1610. Alternatively, in an implementation resembling FIG. 4, models such as STL files may be generated for caps 422 having shaped outward surfaces affected by the surface relief pattern.

Finally, in step 1614, the various models (or multi-object single model) are converted to instructions or commands by which a given additive manufacturing or machining apparatus is directed to form the components. In the case of extrusion, liquid stereolithography or powder bed fusion processes, step 1614 corresponds to ‘slicing’ the models into layers by which the successive build operation will take place. Process 1600 then concludes in step 1620.

FIG. 17 is a conceptual diagram showing how parts may be designed, with coordination of both mutual fit and outer surface features, and then fabricated by additive manufacturing.

A computing device 1710, which may be a desktop, laptop, tablet or mobile smartphone or the like, is shown to host a 3D modelling application 1720 (which may also be referred to as a 3D modeling ‘environment’ or ‘platform’) as evident by a display 1715. 3D modelling application 1720 may reside as software instructions stored in a non-volatile memory within computing device 1710, such as on a magnetic hard disk drive or a solid-state drive component, or stored on a removable non-volatile memory device such as a portable hard drive or so-called ‘thumb drive’ connected via a USB port or the like. From any of these non-volatile, non-transitory forms of computer-readable instructions, computing device 1710 may retrieve or ‘load’ these software instructions into volatile random access memory for much faster access by the processor within the computing device, rendering the computing device capable of manipulating and modifying digital 3D data models and generating output instructions in the manner described in process 1600.

Alternatively, computing device 1710 may connect to a remote source of data via a data communications network, such as the public internet, and either receive the executable software instructions, applets or script files that enable the computing device to act upon the digital data models. As yet another alternative, the functionality for presenting views, performing CSG operations and generating instructions for an additive manufacturing machine may be hosted by a remote server over the data network and merely displayed at computing device 1710.

In FIG. 17, display 1715 is particularly shown to be engaged in creating a knife handle outer cover that roughly comports with FIG. 2 or FIG. 4 shown earlier. An upper cover 1702 is modeled in the display with the top of a fastener or cap being shown in place as if the latter were installed in the corresponding opening in the cover and would appear in the finished assembled article. Described in CSG terminology, the inset fastener or cap 1722 may be defined by intersecting the general shape of cover 1702 with a cylinder shape whereas the cavity within cover 1702 to accommodate the fastener or cap 1722 may be formed by subtracting the same cylinder (or one of slightly larger diameter) from the 3D shape of the cover.

To apply a consistent surface relief pattern to both cover 1702 and fastener or cap 1722, in this example, a relief-defining shape 1704 (only a slice of which is shown for clarity) may be CSG subtracted from cover 1702 and fastener or cap 1722 resulting in the radiused groove surface relief pattern 1705 as shown. If fastener or cap 1722 are placed in their intended final or locked rotational positions during this operation, this will ensure that the fastener or cap will provide a visually consistent appearance when the finished article is assembled. Where a finished article has two covers to be attached by a common fastener, then this modeling procedure is preferably performed with both covers and with all fasteners or caps in their final spatial relationships mirroring the intended physical reality and with the desired relief patterns imposed in both of the respective outward facing surfaces.

Once the defining of component shapes, positioning of components and application of the surface relief pattern are complete, then the finalized 3D models 1725, for example in the form of STL data files, are provided to a ‘slicer’ computing application 1730, which may be hosted by or accessed through computing device 1710 or on a separate computing device. Slicing of the 3D models into movement commands or instructions 1735 for a 3D printer, or other additive manufacturing device may be performed immediately or automatically after generation of the 3D models. Otherwise, or these data models may be stored, communicated or transported and processed into instructions at a different place or time or even in a plurality of instances, such as when the finished models are shared among end users and then additively manufactured using a variety of divergent machines and processes. Aside from targeting additive manufacturing approaches, 3D models 1725 may be converted to CNC tool paths for more traditional ‘subtractive’ machining devices that use cutting, drilling, sawing or other actions to yield a final shape from a billet of material. However, the latter is considered to be less amenable to the present teachings or lacking advantages where the present teachings have sought to leverage the advent of advanced additive manufacturing in creating certain geometries, such as forming inward-protruding tabs 213 or complex shaped cavities 803. Nevertheless, in some circumstances, both additive and subtractive techniques may be advantageously used in combination to form a given finished article.

As one example of an additive manufacturing system or device for creating solid objects from commands 1735, a filament-fed 3D printer 1750 is represented by a simplified, close-up view of the key components, namely filament supply 1752, knurled filament drive wheels 1754, air-cooled stage 1756, heated block 1758 and nozzle 1760. Many other typical mechanical components, motors, bearing systems, etc. are excluded from this view for simplicity but are well known and ubiquitously deployed. In summary, a round internal passage (not shown) exists from air-cooled stage 1756, heated block 1758 and culminating in a small hole through the tip of nozzle 1760. Drive wheels 1754 bear against filament 1752 and, as rotated in a controlled fashion by a motor, drive filament 1752 through the aforementioned passage, forcing the filament material to eventually enter heated block 1758 and become molten and to be discharged through nozzle 1760. The discharge material occurs at specific locations and is deposited onto either a build surface 1751 or onto layers of previously deposited materials, thus forming a solid object. Careful control of motion between the nozzle and build plate as material is discharged results in a solid object having a prescribed shape according to a data model 1725 from which the printer commands 1735 were derived. Air-cooled stage 1756 creates a defined location for a temperature gradient inside the filament passage whereby the filament softens and forms its own ‘perpetuating plunger’ to drive hotter molten material through the nozzle.

The result of the virtual modeling shown on display 1715, the slicing performed by slicing application 1730 and the extrusion printing by 3D printer 1750 is evident on build surface 1751 as real-world parts (cover 1762, fastener 1764 and cap 1766) shaped according to the 3D models and formed from whatever feedstock material is provided in the form of filament 1752. This material may be polymer such as nylon, PETG, ABS, PLA or polyetherimide, for example. It should be reiterated that many other additive manufacturing processes and materials are known and that the presentation of a particular filament printer configuration in FIG. 17 is not intended to imply limitation of the present disclosure or claimed invention to filament printing or to the use of polymer filaments. Indeed, filaments comprising sinterable metal particles in a polymer binder matrix are known for creating metal finished parts.

In the preceding description, various exemplary embodiments have been described with reference to the accompanying drawings. It will be evident, however, that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A method for forming a first fastenable member and an interoperating fastener shaped for use therewith, comprising:
forming the first fastenable member to have a first cylindrical opening for receiving the fastener and to have at least one first tab protruding radially inward from an inner wall of the first cylindrical opening;
forming the fastener to have an overall cylindrical shape around a central axis and to comprise at least one first elongated concavity that is axially-aligned to accommodate passage of the first tab of the first member as the fastener, while kept in a first rotational orientation about the central axis, is inserted into the cylindrical opening of the first member by translating motion of the fastener in line with the central axis in a first axial direction; and
forming the fastener to further include at least one second concavity, confluent with the first concavity, formed in a circumferential direction relative to the cylindrical shape to accommodate passage of the first tab as the fastener is rotated to a second rotational orientation about the central axis after being inserted into the cylindrical opening of the first member;
wherein the first and second concavities are configured so that, when the fastener has been inserted into the first cylindrical opening of the first member by the translating motion in a first direction and then rotated about the central axis, at least one inner wall of the second concavity contacts the first tab and prevents axial movement of the fastener relative to the first member in a second axial direction opposite the first axial direction.

2. The method of claim 1 wherein, in a 3D modeling computer application performing constructive solid geometry calculations, the shape of the first fastenable member is described by a first data model and the shape of the fastener is described by a second data model and the first cylindrical opening is formed by subtracting, from the first data model, a cylindrical shape that encompasses the overall cylindrical shape.

3. The method of claim 2 wherein the fastenable member and the fastener are formed as solid objects by converting the first and second models into instructions for a manufacturing process that comprises additive manufacturing and performing the manufacturing process.

4. The method of claim 1 wherein the first cylindrical opening completely penetrates the first member such that the fastener may be inserted from either side of the first member while kept in the first rotational orientation.

5. The method of claim 1 wherein the first cylindrical opening does not completely penetrate the first member and the fastener may only enter the opening from one side of the first fastenable member.

6. The method of claim 1 wherein the first fastenable member comprises an outward-facing surface having a first pattern of relief features and wherein at least one end of the fastener is formed with a second pattern of relief features such that, when inserted into the first cylindrical opening and rotated to the second rotational orientation, the second pattern of relief features aligns with the first pattern of relief features.

7. The method of claim 6 wherein, in a 3D modeling computer application performing constructive solid geometry calculations, the shape of the first fastenable member is described by a first data model and the shape of the fastener is described by a second data model and the first and second relief features are applied to the first and second data models by a constructive solid geometry operation in combination with a third 3D data model that describes the shape of the relief feature.

8. The method of claim 7 wherein the first fastenable member and the fastener are formed as solid objects by converting the first and second models into instructions for a manufacturing process that comprises additive manufacturing and performing the manufacturing process.

9. The method of claim 1 further comprising:
providing a second fastenable member having a second cylindrical opening for receiving the fastener and having at least one second tab feature protruding radially inward from an inner wall of the second cylindrical opening;
wherein the fastener is configured to be inserted through both the first opening and the second opening simultaneously while in a first rotational orientation, and configured, upon being rotated to a second rotational orientation, to then engage both the first tab and the second tab within said second concavity of the fastener, preventing subsequent separation of the first member and the second member for as long as the fastener remains in the second rotational orientation.

10. The method of claim 9 wherein the first fastenable member comprises an outward-facing surface having a first pattern of relief features, the second fastenable member comprises an outward-facing surface having a second pattern of relief features, and further comprising:
forming the fastener to comprise, at a first axial end, a third pattern of relief features and to comprise, at an opposite second axial end, a fourth pattern of relief features such that, when the fastener is inserted into the first cylindrical opening and rotated to the second rotational orientation, the third pattern comes into conformance with the first pattern and the fourth pattern comes into conformance with the second pattern.

11. The method of claim 10 wherein the fastener is formed to simultaneously provide an appearance of surface continuity between the first and third patterns and between the second and fourth patterns while in the second rotational orientation.

12. The method of claim 10 wherein, in a 3D modeling computer application performing constructive solid geometry calculations, the shape of the first fastenable member is described by a first data model, the shape of the second fastenable member is described by a second data model and the shape of the fastener is described by a third data model and the first and second relief features are applied to the first, second and third data models by a constructive solid geometry operation in combination with at least one fourth data model that describes the shape of a relief feature.

13. The method of claim 12 wherein the first and second fastenable members and the fastener are formed as solid objects by converting the first and second models into instructions for a manufacturing process that comprises additive manufacturing and performing the manufacturing process.

14. The method of claim 9 wherein the first and second fastenable members are shaped to form a handle of a tool and are configured to surround a portion of a tool.

15. The method of claim 14 wherein the tool is a knife and the first and second members are designed to form a grip portion of the knife.

16. A tool handle assembly for enclosing one or more components of a tool, the tool handle assembly comprising:
a fastener formed with at least one axial concavity and at least one circumferential concavity and configured to be inserted, while in a first rotational orientation, by linear motion into a complementary shaped opening in a member to be fastened and then rotated from a first rotational orientation to a second rotational orientation to seat a protrusion from the member into the circumferential concavity, the fastener prevented from axial motion relative to the member while in the second rotational orientation;
a first outer grip member comprising at least one first opening for receiving the fastener and comprising at least first one tab protruding into the opening for engaging the fastener as the fastener is rotated within the first opening; and
a second outer grip member comprising at least second opening for receiving the fastener and comprising at least one second tab protruding into the opening for engaging the fastener as the fastener is rotated within the second opening.
